(19) United States
(12) Patent Application Publication
(10) Pub. No.: US 2013/0144832 A1
(43) Pub. Date: Jun. 6, 2013

(54) APPARATUS AND PROCESS FOR NONDETERMINISTIC COMPUTING

(71) Applicant: Aizhong Li, Ottawa (CA)

(72) Inventor: Aizhong Li, Ottawa (CA)

(21) Appl. No.: 13/310,777

(22) Filed: Dec. 4, 2011

(51) Int. Cl. G06N 5/00; G06F 1/02

(52) U.S. Cl. 706/57; 708/270

(57) ABSTRACT

In the disclosed nondeterministic computing apparatus, a user problem to be solved is translated into an equivalent system of clause polynomial equations (CPEQS) in GF(2). A process for finding an inconsistency in CPEQS is disclosed, which performs elementary equation (or row) operations, such as Gaussian forward eliminations, for each variable v in CPEQS by treating different monomials as different single variables in v-order. The result is examined for two kinds of equations: an inconsistent equation 1=0 and an equation which left-hand side has constant monomial 1 and v occurs in all the other monomials such that v occurs at least once while its right-hand side is 0 to find v=1. To find v=0, a substitution of v with v⊕1 is performed on CPEQS in advance. If either 1=0, or, x=1 and x=0 simultaneously for some variable x in CPEQS, then CPEQS is inconsistent; otherwise CPEQS is consistent.

### TECHNICAL FIELD

The present invention relates to a nondeterministic computing apparatus, or more specifically relates to a process for finding an inconsistency in a system of clause polynomial equations for the execution of the nondeterministic computing apparatus.

### BACKGROUND ART

As known in the prior art, in general, there are two kinds of computing apparatus: deterministic and nondeterministic. A deterministic computing apparatus, such as an electronic computer, is modeled by a deterministic Turing machine (DTM), which has a single sequence of primitive operations for a given input. A nondeterministic computing apparatus is modeled by a nondeterministic Turing machine (NDTM), which may have multiple ‘simultaneous’ or ‘parallel’ sequences of primitive operations for a given input. DTM is a degeneration of NDTM. There are various NP-complete problems in practice, such as the satisfiability problem, the traveling salesman problem, and the integer linear programming problem, which can be solved in polynomial time by a NDTM. If one of them is solved by a DTM in polynomial time, then all of them can be solved by a DTM in polynomial time. Currently there are two approaches to a nondeterministic computing apparatus:
1. A probabilistic or physically nondeterministic computing apparatus to improve the performance at the expense of the loss of correctness within bounded-error rate, for example:
   U.S. Pat. No. 6,463,422: “Probabilistic computing methods and apparatus”;
   U.S. Pat. No. 7,400,282: “Quantum turing machine”;
   U.S. Pat. No. 7,130,093: “Optical implementation of bounded nondeterministic Turing Machines”;
   U.S. Pat. No. 5,843,661: “Method for Construction Universal DNA based Molecular Turing Machine”, and U.S. Pat. No. 6,266,569: “Method and System of Computing Similar to a Turing Machine”.
There are definite advantages to above inventions over the deterministic ones Like quantum computers, however, optical computers or DNA computers are not expected for mass-production in the near future, as there are technical difficulties to overcome, such as how to control the randomness without losing it.
2. A simulated nondeterministic computing apparatus by use of a deterministic apparatus to improve the performance for some specific known cases in terms of heuristics. But the time complexity is still exponential in general. For the satisfiability problem, there are, according to the inventor's best knowledge, two kinds of solutions directly related to the invention in terms of refutation and polynomial equations used:
2.1. Logic based solutions, such as J. A. Robinson's resolution principle. A CNF formula is unsatisfiable if and only if the empty clause (i.e. an inconsistency by refutation) can be derived by resolution operations, with reference made to Chang, C. and R. C. Lee [1973]: Symbolic Logic and Mechanical Theorem Proving, Academic Press, Inc. For example:
   U.S. Pat. No. 7,577,625: “Handling of Satisfaction and Conflicts in a Quantified Boolean Formula Solver”;
   U.S. Pat. No. 7,992,113: “Methods and Apparatus for Decision Making in Resolution based SAT-solvers”; and
   U.S. Pat. No. 7,860,814: “System and Method for Providing a User-selected Best Solution to an NP-complete Scheduling Problem”.
2.2. Algebra based solutions, such as Bruno Buchberger's method of Grobner base can solve polynomial equations in general, in which the concept of monomial ordering plays an important role. For example, U.S. Pat. No. 5,678,055: “Method and Device for Generating Grobner Bases to Reduce Memory Usage and Increase Computing Speed”.
   Wen-Tsun Wu's specific method is more efficient in practice in elementary geometry than Buchberger's general method, where polynomial equations are arranged into row echelon (or triangular) form, with reference made to Cox, D., J. Little and D. O'shea [2007]: IDEAS, VARIETIES, AND ALGORITHMS—An Introduction to Computational Algebraic Geometry and Commutative Algebra, Springer.
   For error correction or encryption, indirectly related to the invention. For example, U.S. Pat. No. 7,865,806: “Methods and Apparatus in Finite Field Polynomial Implementations” over Galois Field GF(n) with n>2; U.S. Pat. No. 6,792,569: “Root Solver and Associated Method for Solving Finite Field Polynomial Equations” disclosed a specific Gaussian elimination that separates the problem of solving quintic and sextic polynomial equations into a simpler problem of finding roots of a quadratic equation and a quartic equation with only one unknown variable.

In summary, “None of us truly understand the P versus NP problem, we have only begun to peel the layers around this increasingly complex question. Perhaps we will see a resolution of the P versus NP problem in the near future but I almost hope not. The P versus NP problem continues to inspire and boggle the mind and continued exploration of this problem will lead us to yet even new complexities in that truly mysterious process we call computation.” quoted from Fortnow, L. [2009]: “The Status of The P versus NP Problem”, Communications of the ACM, Vol. 52, No. 9, 78-86.

### DISCLOSURE OF INVENTION

### The Technical Problem

The purpose of the invention is to provide an efficient realization of a nondeterministic computing apparatus to solve practical problems. With reference made to Aho, A. V., J. E. Hoperoft and J. D. Ullman [1974]: The Design and Analysis of Computer Algorithms, Addison-Wesley; without limiting, a single “tape” nondeterministic Turing machine (NDTM) is denoted by the seven-tuple:
<Q, T, I, δ, b, q₀, q_{f}>where:
   1. Q is the finite set of states of a physical object.
   2. T is the finite set of “tape” symbols, where a string of T represents a physical object.
   3. I is the finite set of input symbols; I is a subset of T. An input string of I represents the physical object at the initial state. Initially the leftmost element of the object is to be processed. In practice, I is often {0, 1} for binary encoding.
   4. b, in T but not I, is the blank, a special delimiter to separate elements of the object.
   5. q₀ is the initial state of a physical object.
   6. q_{f} of is the final (or accepting) state of a physical object.
   7. δ, the next-move function, maps a subset of Q×T to 2^{Q×T×{L, R, S}} where L, R, and S stand for one cell move to the left, right, or stationary, respectively. An allowable move or operation (p, x, q, y, d) in δ represents an action upon the physical object at current state p and on its specific element x to make the current state changed to q, current element x replaced by element y, and then to proceed to the next element determined by direction d.

In one embodiment of the invention, using Java as the programming language, a NDTM is implemented as Java classes and objects as follows:
1. Implementing Q as a Java generic TreeSet<String> object;
2. Implementing T as a Java generic TreeSet<Character> object;
3. Implementing I as another Java generic TreeSet<Character> object;
4. Implementing b as the Java null object;
5. Implementing qₒ as a Java String object;
6. Implementing q_{f} as a Java String object;
7. Implementing δ as a Java Hashtable<Condition, <TreeSet<Action>>> object, where
   Condition is implemented as a Java class with two class members: a String state and a Character symbol;
   Action is implemented as a Java class with three class members: a String state, a
   Character symbol, and a Direction object, where Direction is a Java enum of {R, L, S}.

Therefore storing a NDTM in a computer is implemented by both Java source code and Java serialization. Whether a NDTM accepts an input may be simply simulated by a brute-search until it is accepted, or rejected, or a Java OutOfMemeryError is issued. A more efficient realization of a NDTM is needed in practice.

In the invention the problem is to decide whether a NDTM accepts an input within a given number of steps (or time). The problem can be restated as whether a physical object in its initial state can be transformed into another physical object (including the same object) in the final state by a sequence of allowable operations. If so, the problem may further include finding one or more sequences of operations leading to the final state. It is not difficult to find such sequences by using the principle of Occam's razor after the problem is solved. The time constraint “within a given number of steps (or time)” distinguishes the invention from theoretical research where there is no such a bounded rationality and thus time may be infinite in theory.

The invention solves the 3-CNF satisfiability problem first and then solves the original problem indirectly. The 3-CNF satisfiability problem is to determine whether a 3-CNF formula f has any assignment to some of its variables to make f equal to 1. All variables in f have the same domain {0, 1} where 0, 1 may be interpreted respectively as false and true, yes and no, off and on, and etc. A literal, L, is either a variable x or its negation [symbol] x. A clause, C, is the disjunction of literals L₁ [symbol] . . . [symbol] Lₖ where k≧0. A conjunctional normal form (CNF) formula, f, is the conjunction of clauses C₁ [symbol] . . . [symbol] Cₘ where m>0. A 3-CNF formula is a special CNF formula such that all of its clauses have 3 literals.

In the description of the invention, operator [symbol] is logic negation. Operator [symbol] is logic disjunction. Operator [symbol] is logic conjunction. Galois Field GF(2) “addition” operator ⊕ is logic exclusive OR, that is, x⊕y=(x [symbol] [symbol] y) [symbol] ( [symbol] x [symbol] y). GF(2) “multiplication” operator×has the same meaning as logic conjunction [symbol] .

An introduction to finite field GF(2) is available with reference to Cox, D., J. Little and D. O'shea [2007]: IDEAS, VARIETIES, AND ALGORITHMS—An Introduction to Computational Algebraic Geometry and Commutative Algebra, Springer. An introduction to logic is available with reference to Kleene, S. C. [1967] Mathematical Logic, Dover Publications, Inc.

### Technical Solution to the Problem

The invention provides a solution by translating a user problem into an equivalent system of clause polynomial equations in finite field GF(2) and then finding an inconsistency in the system of clause polynomial equations. By integrating logic and algebra, the solution has the following, but not limited to, outstanding features:
1. The invention may find not only the inconsistency 1=0 (similar to Robinson's empty clause) but also another kind of inconsistency that a variable has both value 0 and value 1 simultaneously in a system of clause polynomial equations by use of GF(2) specific properties, such as, but not limited to:
   A. If x×y=1 then both x=1 and y=1 provided neither GF(2) expressions x nor y is polynomial 0 in normal form; and
   B. x×x=x for any GF(2) expression x, i.e. there is no need to have exponent rather than 1; and
   C. x⊕x=0 for any GF(2) expression x, i.e. there is no need to have coefficient rather than 1; and
2. The invention may use v-order, a monomial total ordering depending on the variable v, different from Buchberger's; and
3. The invention may not use polynomial multiplication or division; and
4. The invention may use efficient Gaussian forward elimination to transform a system of clause polynomial equations into a row echelon form by use of elementary equation (or row) operations in GF(2) by treating different monomials as different single variables. The elementary equation (or row) operations in GF(2) include:
   Interchanging two equations (or rows),
   Exclusive ORing one equation to another equation;
Therefore elementary equation (or row) operations in GF(2) are simpler than those in rational numbers or real numbers.

### ADVANTAGEOUS EFFECTS OF INVENTION

The invention has, but not limited to, the following advantages over the existing devices or processes:
1. The invention is more efficient in both time complexity and space complexity. It is built upon a polynomial time and space process to determine whether a system of clause polynomial equations in GF(2) is inconsistent.
2. The invention solves otherwise intractable problems within a given time.
3. The invention is easy to implement by use of existing experience, for example Gaussian forward elimination is widely available in implementation.
4. The invention is economical to build in mass production in hardware and/or software and thus can be economical to use.
5. The invention is intuitive because in real life there are a lot of problems where comprehensive nondeterministic models are available, for example the VLSI circuit verification problem represented in propositional logic.
6. The invention can employ vector or array based high performance CPU where more efficient Gaussian elimination can be implemented with reference made to Koc, C. K. and S. N. Archchige [1991]: “A Fast Algorithm for Gaussian Elimination over GF(2) and its Implementation on the GAPP”, J. Parallel and Distributed Computing, 13, 118-122.

### DESCRIPTION OF DRAWINGS

The following drawings are exemplary for illustrating the invention. However, the invention is not limited to the specific methods or instrumentalities disclosed. In the drawings:

FIG. 1 is a block diagram of an exemplary computer system in which aspects of the invention may be implemented.

FIG. 2 is a block diagram of the nondeterministic computing components according to one embodiment of the invention.

FIG. 3 is a flow diagram of the steps for finding an inconsistency in a system of clause polynomial equations (CPEQS, for short) in GF(2) according to one embodiment of the invention.

FIG. 4 is a table showing how to translate a 3-CNF clause into an equivalent clause polynomial equation in GF(2) according to one embodiment of the invention.

### MODE FOR INVENTION

### Exemplary Computer System

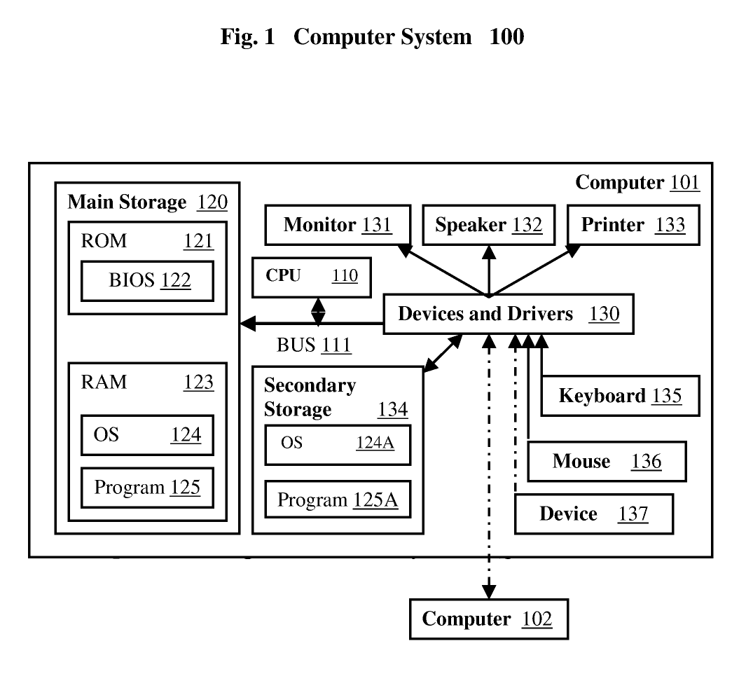

FIG. 1 shows an exemplary computer system, which is embedded into a nondeterministic computing apparatus and aspects of the invention may be implemented. The computer system 100 is only an example of suitable computer systems and it is not intend to suggest any limitation as to any aspect of the invention. The invention may be implemented by use of, but not limited to, an electronic computer, an optical computer, a DNA computer, or a quantum computer, or a combination of them.

The invention may be implemented in general context as software, such as in, but not limited to, shared library form or executable form. The invention may be implemented in general context as hardware, such as, but not limited to, a circuit or a device with a driver (for example device 137). The invention may be implemented as a combination of software and hardware to fulfill the functionality of the invention. The invention may be implemented in parallel or over a network where the functionality of the invention is distributed across two or more CPU's, such as in computer 101 and computer 102.

With reference to FIG. 1, an exemplary computer system 100 is illustrated. In it, computer 101 and 102 are composed of CPU 110, main storage 120, devices and drivers 130, and bus 111 which connecting them together, but not limited to, as shown. Devices and Drivers 130 further are composed of a monitor 131, a speaker 132, a printer 133, a secondary storage 134, a keyboard 135, a mouse 136; and optionally, one or more other device 137 (for example a digital camera) and one or more other computer 102, connected by, but not limited to, network interface or direct link. The main storage includes nonvolatile ROM 121 and volatile RAM 123. In addition to BIOS 122, an embodiment of the invention may be stored inside ROM 121. The nonvolatile secondary storage 134 further includes, but not limited to, OS 124A and one or more program 125A, which may include an embodiment of the invention, as a part or a whole of the invention. Loaded OS 124 is either a part or the whole of OS 124A. Loaded program 125 is either a part or the whole of program 125A.

### Nondeterministic Computing Components

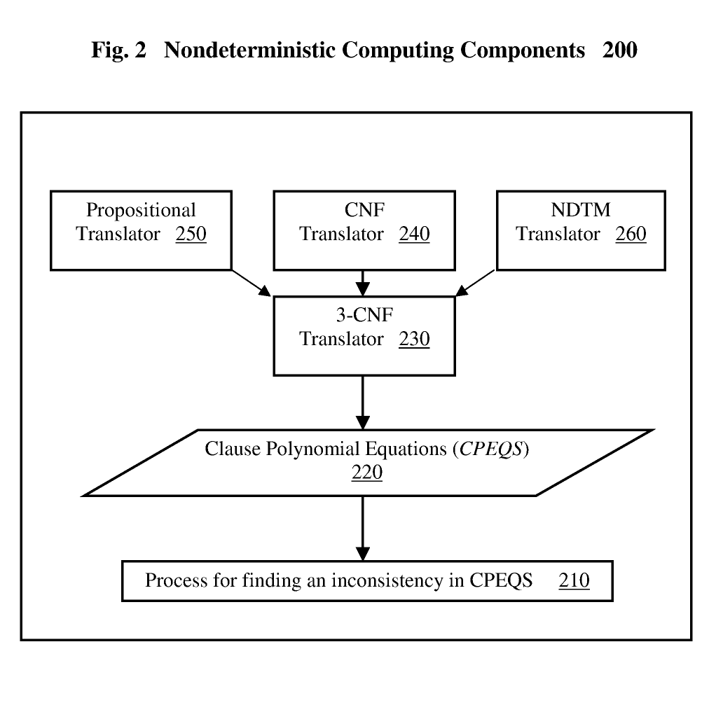

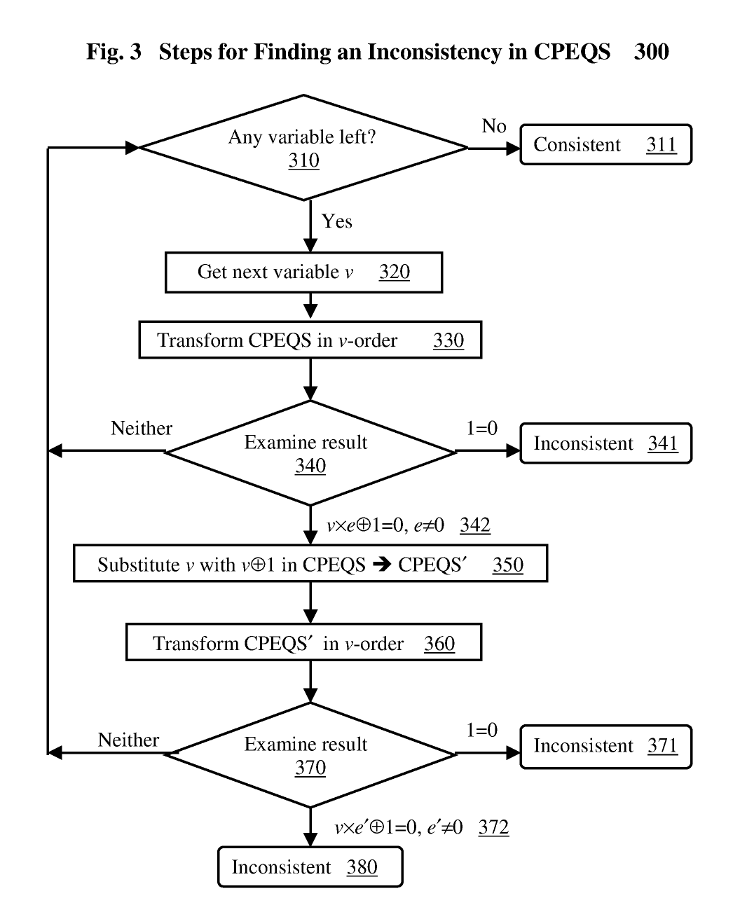

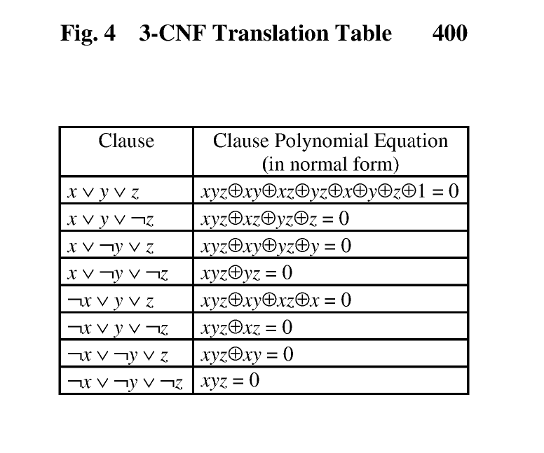

With reference to FIG. 2, according to one embodiment of the invention, nondeterministic computing components 200 composing:
Propositional translator 250 translating a propositional formula into an equivalent 3-CNF formula where Tseitin's linear time algorithm is available with reference made to Tseitin, G. S. [1965]: “On the Complexity of Derivation in Propositional Calculus” in A. O. Slisenko, editor, Studies in Constructive Mathematics and Mathematical Logic, Consultants Bureau, New York-London, part 2, 156-169;
CNF translator 240 translating a CNF formula into an equivalent 3-CNF formula where a linear time translation is available with reference made to Cook, S. A. [1971]: “The Complexity of Theorem Proving Procedures”, Proc. 3rd Annual ACM Symposium on Theory of Computing, 151-158;
NDTM translator 260 translating a NDTM, along with a given input and a time complexity constraint, into an equivalent 3-CNF formula where an efficient translation is available with reference made to Cook, S. A. [1971]: “The Complexity of Theorem Proving Procedures”, Proc. 3rd Annual ACM Symposium on Theory of Computing, 151-158;
3-CNF translator 230 translating a 3-CNF formula into an equivalent system of clause polynomial equations (CPEQS, for short) in GF(2). Given 3-CNF formula f=C₁ [symbol] . . . [symbol] Cₘ, where m>0, and Cᵢ=Lᵢ₁ [symbol] Lᵢ₂ [symbol] Lᵢ₃ for all 1≦i≦m. CPEQS consists of m clause polynomial equations corresponding to each clause Cᵢ in f. For each clause Cᵢ, its corresponding clause polynomial equation is given in, but not limited to, the lookup table in FIG. 4. A GF(2) polynomial is in normal form if it is in the format of m₁⊕ . . . ⊕mₙ where n>=0 and mᵢ≠mⱼ if i≠j and for all 1≦k≦n mₖ is a monomial, which is either constant 1 or a multiplication of one or more variables. The right side of a clause polynomial equation is always 0 for the purpose of easy treatment only. Clause polynomial equations do not include all GF(2) equations. But a system of GF(2) equations in general is a propositional formula, by use of propositional translator 250, it can be translated into an equivalent 3-CNF formula. Once CPEQS is obtained, the process for finding an inconsistency in CPEQS 210 is fulfilled in details by the steps for finding an inconsistency in CPEQS 300 with reference made to FIG. 3.

Steps for Finding an Inconsistency in a System of Clause Polynomial Equations

With reference made to FIG. 3, given 3-CNF formula f and its equivalent system of clause polynomial equations (CPEQS, for short). According to one embodiment of the invention, the steps for finding an inconsistency in CPEQS are composed of the following steps:
310. Check if there is a variable in f left to be tested;
311. If all variables have been tested, then f is satisfiable and the process terminates; otherwise
320. Test the next variable v as follows:
330. Sort monomials in the left-hand side of each equation of CPEQS in a total ordering v-order such that monomials without v appear first from left, monomials with v appears after, constant 1 appears the last if any occurs, to control the following transformation to eliminate monomials without v first, monomials with v after, constant 1 the last. Then perform Gaussian forward elimination on the sorted CPEQS by treating different monomials as different single variables.
340. Examine the result of step 330. There are three cases:
   341. If there is an equation 1=0, then f is inconsistent and the process terminates; otherwise
   342. If there is an equation which left-hand side has constant monomial 1 and v occurs in all the other monomials such that v occurs at least once (it means that v=1 is found), then go to step 350; otherwise go to step 310 to test the next variable.
350. In order to find v=0, substitute v with v⊕1 in CPEQS to obtain new equations CPEQS'.
360. Sort monomials in the left-hand side of each equation of CPEQS′ in a total ordering v-order such that monomials without v appear first from left, monomials with v appears after, constant 1 appears the last if any occurs, to control the following transformation to eliminate monomials without v first, monomials with v after, constant 1 the last. Then perform Gaussian forward elimination on the sorted CPEQS′ by treating different monomials as different single variables. It is similar to step 330 except the equations may be different.
370. Examine the result of step 360. There are three cases:
   371. If there is an equation 1=0, then f is inconsistent and the process terminates; otherwise
   372. If there is an equation which left-hand side has constant monomial 1 and v occurs in all the other monomials such that v occurs at least once (it means v=0 is found in addition to v=1 simultaneously in CPEQS), then f is inconsistent and the process terminates at 380; otherwise go to step 310 to test the next variable.

### CITATION LIST

### US Patents Referenced (with Keywords in Bold for Easy Patent Search)

| Number | Inventor | Year | Title |
|---|---|---|---|
| 6,463,422 | Hangartner | 2002 | Probabilistic computing methods and |
| | | | apparatus |
| 7,400,282 | Tanaka, et al. | 2008 | Quantum turing machine |
| 7,130,093 | Dolev, et al. | 2006 | Optical implementation of bounded |
| | | | non-deterministic Turing Machines |
| 5,843,661 | Rothemund | 1998 | Method for construction universal |
| | | | DNA based molecular turing machine |
| 6,266,569 | Shapiro, et al. | 2001 | Method and system of computing |
| | | | similar to a turing machine |
| 7,577,625 | Zhang | 2009 | Handling of satisfaction and conflicts |
| | | | in a quantified Boolean formula |
| | | | solver |
| 7,992,113 | Goldberg | 2011 | Methods and apparatus for decision |
| | | | making in resolution based SAT |
| | | | solvers |
| 7,860,814 | Plotnick | 2010 | System and method for providing a |
| | | | user-selected best solution to an |
| | | | NP-complete scheduling problem |
| 5,678,055 | Noro | 1997 | Method and device for generating |
| | | | Grobner bases to reduce memory |
| | | | usage and increase computing speed |
| 7,865,806 | Lablans | 2011 | Methods and apparatus in finite field |
| | | | polynomial implementations |
| 6,792,569 | Cox, et al. | 2004 | Root solver and associated method |
| | | | for solving finite field polynomial |
| | | | equations |

### Other References

Fortnow, L. [2009]: “The Status of The P versus NP Problem”, Communications of the ACM, Vol.52, No.9, 78-86.
Aho, A. V., J. E. Hoperoft and J. D. Ullman [1974]: The Design and Analysis of Computer Algorithms, Addison-Wesley.
Chang, C. and R. C. Lee [1973]: Symbolic Logic and Mechanical Theorem Proving, Academic Press, Inc.
Cox, D., J. Little and D. O'shea [2007]: IDEAS, VARIETIES, AND ALGORITHMS
   An Introduction to Computational Algebraic Geometry and Commutative Algebra, Springer.
Koc, C. K. and S. N. Archchige [1991]: “A Fast Algorithm for Gaussian Elimination over GF(2) and its Implementation on the GAPP”, J. Parallel and Distributed Computing, 13, 118-122.
Tseitin, G. S. [1965]: “On the Complexity of Derivation in Propositional Calculus” in A. O. Slisenko, editor, Studies in Constructive Mathematics and Mathematical Logic, Consultants Bureau, New York-London, part 2, 156-169.
Cook, S. A. [1971]: “The Complexity of Theorem Proving Procedures”, Proc. 3rd Annual ACM Symposium on Theory of Computing, 151-158.
Kleene, S. C. [1967] Mathematical Logic, Dover Publications, Inc.

1. A nondeterministic computing apparatus, composing:
One or more computer systems for, but not limited to, inputting one or more user problems and outputting their corresponding results; and
One or more nondeterministic computing components.

2. The formats of the said user problems of claim [1], composing:
Propositional formulae, and
CNF formulae, and
NDTM's with their respective pairs of an input and a time constraint, and
3-CNF formulae, and
Systems of clause polynomial equations in Galois Field GF(2).

3. The said nondeterministic computing components of claim [1], composing:
Zero, one or more translators;
One or more systems of clause polynomial equations;
One or more processes for finding an inconsistency in the said system of clause polynomial equations.

4. The said translators in claim [3], composing:
A propositional translator translating a propositional formula into an equivalent 3-CNF formula; and
A CNF translator translating a CNF formula into an equivalent 3-CNF formula; and
A NDTM translator translating a NDTM with an input and a time constraint into an equivalent 3-CNF formula; and
A 3-CNF translator translating a 3-CNF formula into an equivalent system of clause polynomial equations in GF(2);
Wherein translating problem A into an equivalent problem B means that the result of the problem A can be obtained from the result of the problem B.

5. A process for finding an inconsistency in a system of clause polynomial equations (CPEQS, for short), composing:
Substituting a variable v in CPEQS with v⊕1to obtain CPEQS′; and
Transforming CPEQS and/or CPEQS′ into REF and/or REF′, respectively; and
Examining REF and/or REF′, composing:
If there is some equation which left-hand side has constant monomial 1 and variable v occurs in all the other monomials such that v occurs at least once while its right-hand side is 0 (or its equivalent equation) in both REF and REF′, CPEQS is inconsistent;
If there is equation 1=0 (or its equivalent equation) in either REF or REF′, CPEQS is inconsistent;
A sequence of the said substituting, transforming and examining steps.

6. The said system of clause polynomial equations of claim [5], composing:
Equations in GF(2) equivalent to, but not limited to, respective clauses in a 3-CNF expression;
The said equations having its right-hand side as, but not limited to, 0 for easy treatment.

7. The said transforming step of claim [5], composing:
Interchanging two equations as an elementary operation; and
Exclusive ORing equation A and equation B to obtain equation C and then replacing equation B with equation C, as the another elementary operation; and
A sequence of the said two elementary operations.

8. The said transforming of claim [7], composing, but not limited to
Transforming the said system of clause polynomial equations in v-order into row echelon form by use of Gaussian elimination in GF(2) by treating different monomials as different single variables, where the said v-order for variable v is a total monomial ordering such that monomials without v appear first from left, monomials with v appears after, constant 1 appears the last if any occurs, and the said v-order is used to control the transforming such that monomials without v eliminated first, monomials with v eliminated after, constant 1 eliminated the last if any occurs.
